(19) United States
(12) Patent Application Publication
(10) Pub. No.: US 2011/0147029 A1
(43) Pub. Date: Jun. 23, 2011

(54) Hand-guided power tool having a torque coupling

(76) Inventors: Heiko Roehm, Stuttgart (DE); Tobias Herr, Stuttgart (DE)

(21) Appl. No.: 12/926,911

(22) Filed: Dec. 17, 2010

(30) Foreign Application Priority Data
Dec. 18, 2009 (DE) 10 2009 054 931.5

(51) Int. Cl. B25F 5/00; B25B 21/00; B23B 47/04

(52) U.S. Cl. 173/176; 173/47

(57) ABSTRACT

A hand-guided power tool according to the invention, has a torque coupling, and a planetary gear disposed in a gearbox for transmitting a torque, generated by a drive motor, to a drive shaft. The planetary gear has at least one ring gear, axially displaceable in the gearbox, for releasing the torque coupling.

### CROSS-REFERENCE TO RELATED APPLICATION

This application is based on German Patent Application 10 2009 054 931.5 filed on Dec. 18, 2009.

### BACKGROUND OF THE INVENTION

1. Field of the Invention

The present invention relates to a hand-guided power tool having a torque coupling, which power tool has a planetary gear, disposed in a gearbox, for transmitting a torque, generated by a drive motor, to a drive shaft.

2. Description of the Prior Art

From the prior art, hand-guided power tools of this kind are known in which the planetary gear has a ring gear, which is provided with detent bodies and which with associated, axially displaceable pressure bodies embodies a torque coupling, to which a maximum allowed torque, which is adjustable via a final control element, is assigned. The pressure bodies and thus blocking members provided on them are pressed by spring elements, with a predetermined contact pressure, against a face end of the ring gear, on which end the detent bodies are embodied. In operation of these power tools, these blocking members block the detent bodies until the maximum allowed torque is reached, so that rotation of the ring gear in the gearbox is prevented. When this torque is exceeded, the detent bodies can be moved, counter to the force of the spring elements, past the blocking members embodied on the pressure bodies, so that rotation of the ring gear in the gearbox is made possible.

It is a disadvantage of the prior art that the spring elements must be comparatively large, to ensure safe, stable functioning of the torque coupling. However, such spring elements require comparatively major adjusting forces upon adjustment of the maximum allowed torque, and these forces can lead to sacrifices in convenience in the use of the power tool.

### OBJECT AND SUMMARY OF THE INVENTION

One object of the invention is therefore to furnish a novel hand-guided power tool that has an improved torque coupling.

This object is attained by a hand-guided power tool having a torque coupling, which power tool has a planetary gear, disposed in a gearbox, for transmitting a torque, generated by a drive motor, to a drive shaft. The planetary gear has at least one ring gear, axially displaceable in the gearbox, for releasing the torque coupling.

The invention thus makes it possible to furnish a hand-guided power tool in which a distribution of forces in the torque coupling is achieved, in which tooth friction forces and/or bearing friction forces engage the axially displaceable ring gear, and these forces contribute to maintaining a suitable coupling position and have to be overcome upon an axial displacement of the ring gear.

In one embodiment, in the vicinity of a face end of the ring gear, which end faces away from a pressure body associated with the torque coupling, a bracing element, which is axially immovable and is disposed in a manner fixed against relative rotation, is provided in the gearbox.

Stable axial bracing of the ring gear can thus be achieved in a simple way.

The bracing element, on its side oriented toward the ring gear, has at least one blocking member.

Thus an inexpensive, uncomplicated component for the torque coupling can be furnished.

Preferably, the ring gear, on its face end which faces away from a pressure body associated with the torque coupling, has at least one detent body.

Thus a simple detent geometry that cooperates with the blocking members of the bracing element can be embodied on the ring gear.

The at least one blocking member and/or the at least one detent body preferably has at least one bulge.

Thus blocking members and/or detent bodies that can be embodied inexpensively and in an uncomplicated way can be achieved.

In one embodiment, the at least one blocking member is embodied for blocking the at least one detent body upon a rotation of the drive shaft until a predeterminable torque is reached.

The invention thus makes it possible to furnish a power tool that has a safe and reliable torque coupling, with which coupling a stable coupling position of the ring gear is attainable.

The at least one blocking member and the at least one detent body are preferably embodied for effecting an axial displacement of the ring gear when the predeterminable torque is reached.

A release of the coupling and thus a release of the ring gear can thus be achieved in a simple way when the predeterminable torque is reached.

In one embodiment, at least one axially displaceable pressure element, contacting a face end of the ring gear, which face end faces away from the at least detent body, is provided, which is embodied for exerting a predetermined contact pressure on the ring gear.

The invention thus makes a stable, secure hold of the ring gear in the associated coupling position possible, and the face acted upon the pressure body and the face having the detent bodies are disposed on face ends, facing away from one another, of the ring gear.

Preferably, at least one compression spring is provided, which is embodied for urging the pressure element against the ring gear with the predetermined contact pressure.

Thus a safe, reliable functionality of the torque coupling can be achieved with simple, inexpensive components.

The face end of the ring gear facing away from the at least one detent body preferably faces away from the drive motor. The face end of the ring gear facing away from a pressure body associated with the torque coupling preferably faces toward the drive motor.

Thus a simple, compact construction of the hand-guided power tool can be achieved.

The object mentioned at the outset is also attained by a planetary gear, which is disposed in an associated gearbox, in which at least one axially displaceable ring gear is provided in the gearbox, for releasing an associated torque coupling.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a schematic view of a hand-guided power tool in a first embodiment; and

FIG. 2 is an enlarged sectional view of a detail of the power tool of FIG. 1.

### DESCRIPTION OF THE PREFERRED EMBODIMENTS

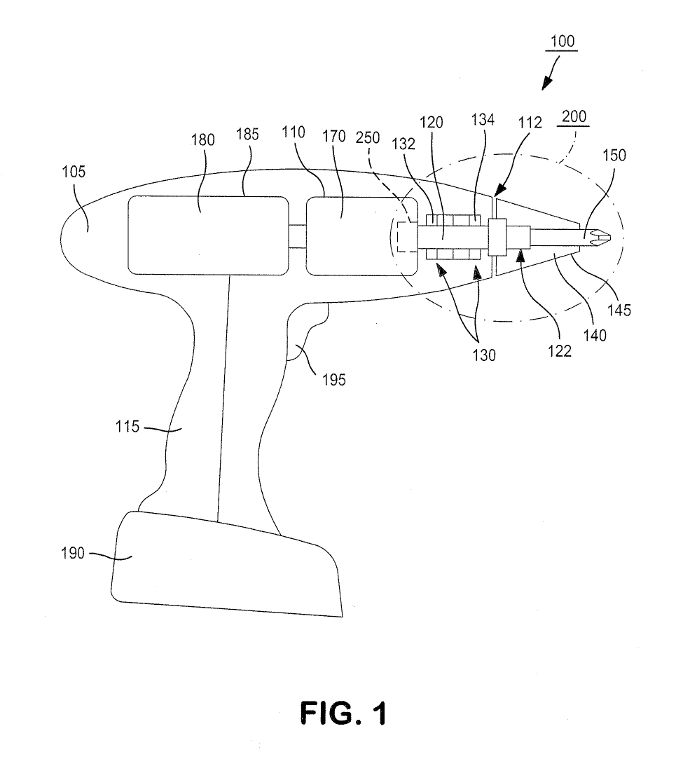

FIG. 1 shows a hand-guided power tool 100, which has a housing 105 with a handle 115. In one embodiment, the power tool 100 can be connected mechanically and electrically to a rechargeable battery pack 190, for supplying cordless power. In FIG. 1, the power tool 100 is embodied as a cordless power drill/driver. However, it will be noted that the present invention is not limited to cordless power drill/drivers but instead can be employed in various power tools, especially cordless power tools, in which a tool is set into rotation, such as in a cordless screwdriver, a cordless impact drill, etc.

An electric drive motor 180, supplied with current by the battery pack 190, and a gear 170 are disposed in the housing 105. The drive motor 180 is connected to a drive shaft 120 via the gear 170. The drive motor 180 is disposed for the sake of illustration in a motor housing 185, and the gear 170 is disposed in a gearbox 110; the gearbox 110 and the motor housing 185 are disposed for example in the housing 105.

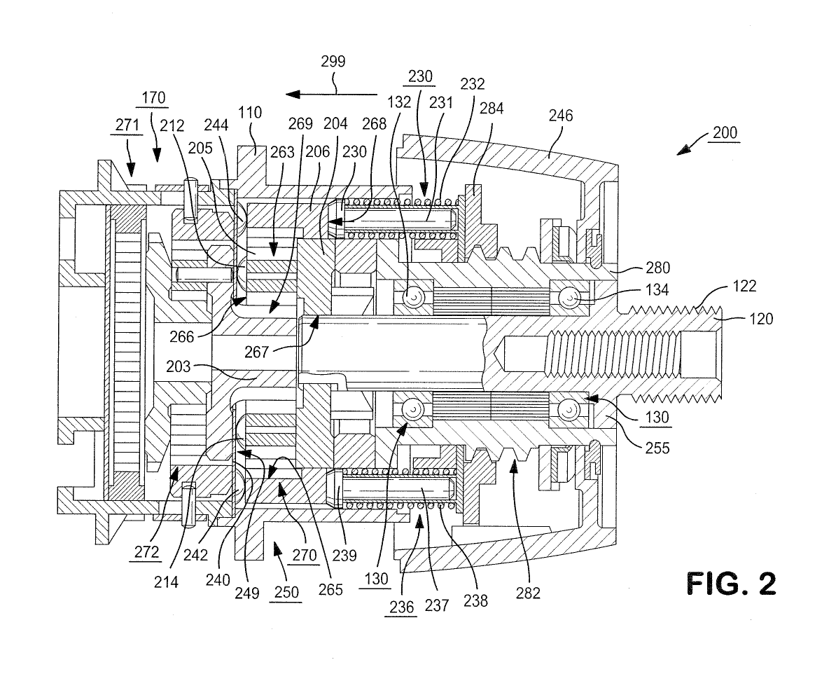

The gear 170, in one embodiment, is a planetary gear embodied with various gear or planet stages, and the planetary gear is assigned a torque coupling 250. In operation of the power tool 100, the planetary gear 170 is driven to rotate by the drive motor 180. The planetary gear 170 will be described in detail below with reference to an enlarged sectional view of a detail 200 in FIG. 2.

The drive motor 180 is actuatable, or in words can be turned on and off, for instance via a manual switch 195, and it can be an arbitrary type of motor, such as an electronically commutated motor or a direct current motor. Preferably, the drive motor. 180 is electronically controllable or regulatable in such a way that both a reverse mode of operation and specifications for a desired rotary speed can be implemented. The mode of operation and the construction of a suitable drive motor are well enough known from the prior art that a detailed description will be dispensed with here, to keep the specification concise.

The drive shaft 120 is supported rotatably in the housing 105 via a bearing arrangement 130 and is provided with a tool holder 140, which is disposed in the vicinity of one face end 112 of the housing 105 and has a drill chuck 145, for example. The bearing arrangement 130 may be secured to the housing 105, for instance via associated securing elements, or it may be disposed in an associated intermediate element, such as the gearbox 110 or the motor housing 185. The tool holder 140 serves to receive a tool 150 and can be integrally formed onto the drive shaft 120 or joined to it in the form of an attachment. In FIG. 1, the tool holder 140 is embodied as an attachment, as an example, and is secured to the drive shaft 120 via a securing device 122 provided on the drive shaft.

The bearing arrangement 130, in one embodiment, has a first bearing 134 and a second bearing 132 spaced apart from the first, and these bearings, as shown in FIG. 2, are embodied for example as ball bearings. However, it will be noted that other types of bearing can also be used within the scope of the present invention. For instance, the bearings 132, 134 may alternatively be implemented in the form of slide bearings, needle bearings, roller bearings, or other types of antifriction bearings.

FIG. 2 shows the detail 200 of the hand-guided power tool 100 of FIG. 1, in which for the sake of clarity and simplicity of the drawing, the tool 150 and the tool holder 140 of FIG. 1 have not been shown. The detail 200 illustrates one exemplary embodiment of the planetary gear 170, bearing arrangement 130, drive shaft 120, and torque coupling 250.

The planetary gear 170 has for example three gear or planet stages disposed in the gearbox 110: a front stage 270, a rear stage 271, and a middle stage 272. The front planet stage 270 has a sun wheel 203, for example, with a set of teeth 269, at least one planet wheel 205 with a set of teeth 263, a planet carrier or slaving means 204 with a rotary slaving contour 267, and a ring gear 206 with a set of teeth 265. Since the layout of a planetary gear is adequately well known to one skilled in the art, further description of the planet stages 271, 272 will be dispensed with here for the sake of a concise description. The torque of the drive motor 180 of FIG. 1 is transmitted to the drive shaft 120 via the planet stages 271, 272, 270 by means of the rotary slaving contour 267 of the slaving means 204.

The drive shaft 120 has the securing device 122, embodied for purposes of illustration as a male thread, on which the drill chuck 145 of the tool holder 140 of FIG. 1 can be secured; the male thread can be put into threaded engagement with a female thread provided for instance on the drill chuck 145. In one embodiment, the drive shaft 120 is embodied as a drive spindle with a bracing flange 255, so that the bearings 132, 134 of the bearing arrangement 130 act as spindle bearings. The bearings 132, 134 are disposed in a bush or bearing sleeve 280, provided with a male thread 282, and an adjusting ring 246, for instance, is supported rotatably on the bearing sleeve 280. The adjusting ring is in operative engagement with a lock nut 284, which is supported rotatably on the male thread 282 of the bearing sleeve 280.

For the sake of illustration, a first pressure body 230 and a second pressure body 236 are axially braced on the lock nut 284. The first pressure body 230 for instance has a compression spring 232, which urges a hemispherical or mushroom-shaped widened portion 233 of a pressure pin 231 with a predetermined contact pressure in the direction of an arrow 299 against a face end 268 of the ring gear 206, which end faces toward the pressure body 230 or 236 and thus for the sake of illustration away from the drive motor 180 of FIG. 1. The second pressure body 236 has for example a compression spring 238, which likewise urges a hemispherical or mushroom-shaped widened portion 239 of a pressure pin 237 with the predetermined contact pressure in the direction of the arrow 299 toward the face end 268 of the ring gear 206.

However, it will be noted that pressure pins 231, 237 are shown merely as examples and do not limit the invention to the use of such pressure elements. On the contrary, pressure bodies with alternative pressure elements can also be implemented, by way of which the face end 268 of the ring gear 206 can be urged with the predetermined contact pressure. For instance, the compression springs 232, 238 can act directly on pressure balls and press them against the face end 268. Thus in comparison to the pressure pins 231, 237, pressure elements can be furnished which operate with comparatively little friction upon a rotation of the ring gear 206. Alternatively to this, the compression springs 232, 238 can also press directly against the face end 268 of the ring gear 206.

In one embodiment, the ring gear 206 is disposed axially movably in the gearbox 110. On its face end 266, facing away from the pressure bodies 230, 236 and thus for the sake of illustration toward the drive motor of FIG. 1, one or more detent bodies 212, 214 are embodied, which are integrally formed for example as bulges onto this face end 266. In the vicinity of this face end 266, there is a bracing element 240, such as a support plate, that is axially and radially immovable in the gearbox 110. This bracing element or support plate, on its side 249 toward the ring gear 206, has one or more blocking members 242, 244, which are integrally formed onto the plate 240, for example in the form of bulges. The bulges 212, 214 and 242, 244 are embodied for the sake of illustration in the form of spherical segments. However, it will be noted that arbitrary embodiments of the detent bodies 212, 214 and blocking members 242, 244 are possible, as long as the functionality, described below, of the torque coupling 250 can be attained thereby.

As can be seen from FIG. 2, the torque coupling 250, embodied by the pressure bodies 230, 236, the ring gear 206, the bracing element 240, and the lock nut 284 or adjusting ring 246, is disposed in the vicinity of the front planet stage 270. However, this should be understood as only an example, and not as a limitation of the invention. On the contrary, the torque coupling 250 can be embodied in conjunction with an arbitrary planet stage.

In operation of the power tool 100 of FIG. 1, the blocking members 242, 244 serve, upon a rotation of the drive shaft 120, to block the detent bodies 212, 214 until a predeterminable torque is reached, so that the ring gear 206 and the bracing element 240 are coupled rigidly to one another, or in other words are not rotatable relative to one another. For that purpose, the ring gear 206 is first pressed by the pressure bodies 230, 236, by means of the force of the compression springs 232, 238, in the direction of the arrow 299 with a predetermined contact pressure against the bracing element 240, and is kept in a corresponding coupling or blocking position in which the blocking members 242, 244 block the detent bodies 212, 214, so that the ring gear 206 cannot rotate. The contact pressure here is adjustable by rotation of the adjusting ring 246 and thus of the lock nut 284; the lock nut 284 is preferably adjustable or rotatable in such a way that it can suppress or block an axial displacement of the ring gear 206 completely, or in other words independently of torque, in a so-called “drilling position”. Alternatively, a suitable blocking element can be used for limiting the axial displacement of the ring gear 206, in order to block the ring gear in the drilling position.

In the coupling mode of the torque coupling 250, tooth friction forces between the sets of teeth 263, 264 and/or bearing friction forces of the planet wheels 205 are operative; they originate in a torque transmitted to the drive shaft 120. These friction forces act counter to an axial motion of the ring gear 206 and thus act to support the compression springs 232, 238, and hence these springs can be designed with comparatively slight spring forces. This in turn makes a comparatively weakened latching of the adjusting ring 246 on the bearing sleeve 280 possible, since a corresponding tendency of the lock nut 284 to return to its original position can be at least reduced by the low spring forces of the compression springs 232, 238. Thus upon an actuation of the adjusting ring 246, only relatively low user-exerted forces are required, making the power tool 100 of FIG. 1 more convenient to use.

When the predeterminable torque is reached, the blocking members 242, 244 and the detent bodies 212, 214, for releasing the torque coupling 250, effect an axial displacement of the ring gear 206 counter to the aforementioned friction forces and to the spring forces of the compression springs 232, 238, whereupon the detent bodies 212, 214 are displaced past associated blocking members 242, 244 in the manner of a ratchet motion. Thus the coupling between the ring gear 206 and the bracing element 240 is released, and a rotation of the ring gear 206 in the gearbox 110 relative to the bracing element 240 is thus enabled.

The foregoing relates to preferred exemplary embodiments of the invention, it being understood that other variants and embodiments thereof are possible within the spirit and scope of the invention, the latter being defined by the appended claims.

1. A hand-guided power tool having a torque coupling, which power tool has a planetary gear disposed in a gearbox which transmits a torque generated by a drive motor to a drive shaft, the planetary gear having at least one ring gear, axially displaceable in the gearbox, for releasing the torque coupling.

2. The power tool as defined by claim 1, wherein in a vicinity of a face end of the ring gear, which face end faces away from a pressure body associated with the torque coupling, a bracing element, which is axially immovable and is disposed in a manner fixed against relative rotation, is provided in the gearbox.

3. The power tool as defined by claim 2, wherein the bracing element, on its side oriented toward the ring gear, has at least one blocking member.

4. The power tool as defined by claim 3, wherein the ring gear, on its face end which faces away from a pressure body associated with the torque coupling, has at least one detent body.

5. The power tool as defined by claim 4, wherein the at least one detent body has at least one bulge.

6. The power tool as defined by claim 3, wherein the at least one blocking member has at least one bulge.

7. The power tool as defined by claim 5, wherein the at least one blocking member has at least one bulge.

8. The power tool as defined by claim 3, wherein the at least one blocking member is embodied for blocking the at least one detent body upon a rotation of the drive shaft until a predeterminable torque is reached.

9. The power tool as defined by claim 4, wherein the at least one blocking member is embodied for blocking the at least one detent body upon a rotation of the drive shaft until a predeterminable torque is reached.

10. The power tool as defined by claim 8, wherein the at least one blocking member and the at least one detent body are embodied for effecting an axial displacement of the ring gear when the predeterminable torque is reached.

11. The power tool as defined by claim 9, wherein the at least one blocking member and the at least one detent body are embodied for effecting an axial displacement of the ring gear when the predeterminable torque is reached.

12. The power tool as defined by claim 4, wherein at least one axially displaceable pressure element, contacting a face end of the ring gear, which face end faces away from the at least detent body, is provided, which is embodied for exerting a predetermined contact pressure on the ring gear.

13. The power tool as defined by claim 5, wherein at least one axially displaceable pressure element, contacting a face end of the ring gear, which face end faces away from the at least detent body, is provided, which is embodied for exerting a predetermined contact pressure on the ring gear.

14. The power tool as defined by claim 8, wherein at least one axially displaceable pressure element, contacting a face end of the ring gear, which face end faces away from the at least detent body, is provided, which is embodied for exerting a predetermined contact pressure on the ring gear.

15. The power tool as defined by claim 10, wherein at least one axially displaceable pressure element, contacting a face end of the ring gear, which face end faces away from the at least detent body, is provided, which is embodied for exerting a predetermined contact pressure on the ring gear.

16. The power tool as defined by claim 8, wherein at least one compression spring is provided, which is embodied for urging the pressure element against the ring gear with the predetermined contact pressure.

17. The power tool as defined by claim 12, wherein the face end of the ring gear facing away from the at least one detent body faces away from the drive motor.

18. The power tool as defined by claim 16, wherein the face end of the ring gear facing away from the at least one detent body faces away from the drive motor.

19. The power tool as defined by claim 2, wherein the face end of the ring gear facing away from a pressure body associated with the torque coupling faces toward the drive motor.

20. A planetary gear, which is disposed in an associated gearbox, wherein at least one axially displaceable ring gear is provided in the gearbox, for releasing an associated torque coupling.
